(19) United States
(12) Patent Application Publication
(10) Pub. No.: US 2009/0180188 A1
(43) Pub. Date: Jul. 16, 2009

(54) BROADBAND ANTIREFLECTIVE OPTICAL COMPONENTS WITH CURVED SURFACES AND THEIR PRODUCTION

(75) Inventors: Konrad Bach, Tiefthal (DE); Daniel Gaebler, Ilmenau (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: X-FAB SEMICONDUCTOR FOUNDRIES AG, Erfurt (DE)

(21) Appl. No.: 12/294,129

(22) PCT Filed: Mar. 23, 2007
(86) PCT No.: PCT/EP2007/052818

§ 371 Date: Mar. 26, 2009

(30) Foreign Application Priority Data
Mar. 24, 2006 (DE) 10 2006 013 670.5

(51) Int. Cl. G02B 1/11; G02B 5/30

(52) U.S. Cl. 359/601; 264/1.31; 359/580

(57) ABSTRACT

Methods and optical devices are proposed, which comprise a nanostructure (4) on a curved surface so that a broadband antireflective characteristic is obtained. The nanostructure is fabricated by means of a self-masking single step etch process of silicon (3) on the curved surface

### FIELD OF THE PRESENT INVENTION

The present invention generally relates to manufacturing techniques and optical devices having a curved surface, which exhibit light refraction capabilities (a positive or negative refraction of rays of incident light). The light is within a given wavelength range, wherein antireflective characteristics of the optically effective surface (the curved surface) are to be achieved on the basis of the present invention.

### RELATED ART

An antireflective behaviour or blooming of optically effective curved surfaces, which thus generate a negative or positive converging effect for light rays incident on the surface, has been a problem since the beginning of the first antireflective coatings at the beginning of the 20^{th} century. Antireflective coatings on the basis of the interference phenomena require homogenous characteristics of the applied layers, in particular the thickness values thereof have to be carefully adapted to each other. Any known methods producing this type of antireflective behaviour have to deal with this problem. A further problem is the adhesion of the applied layers and the effectivity over a frequently strongly restricted wavelength range. Only complex layer systems allow an antireflective behaviour over an increased wavelength range. Corresponding layer systems, however, are in particular very demanding with respect to the homogeneity of the layers and tend to provide a reduced adhesion caused by the combination of the occurring mechanical layer stresses. Furthermore, layer materials are not appropriate for each wavelength range.

Electronic devices, opto electronic devices, sensors or micromechanical devices frequently comprise optical components as an integral part, which require curved surfaces for processing optical signals, wherein the total efficiency of these optical components strongly depends on the fraction of the portion of radiation coupled into the surface. Also in this case, an efficient antireflective behaviour is important, wherein also the compatibility of the processes for manufacturing the antireflective coatings with respect to the further integration processes is an important aspect. Frequently, the complex structures of the conventional antireflective structures result in complex and thus cost-intensive manufacturing steps, wherein a broadband effect of the antireflective coatings is, however, rarely accomplished.

### SUMMARY OF THE INVENTION

It is an object of the present invention to provide such an implementation of a surface for optical components having curved surfaces, as are provided as integral parts of opto electronic integrated circuits, as individual devices or also as pure optical components of appliances, in order to obtain a significantly reduced reflection over a wide (or: broad) wavelength range.

According to the present invention for this purpose a layer of a base material having a curved surface is formed, which causes a substantially gradual adaptation of the index of refraction of the base material to the surrounding medium, at least for the light wavelength range under consideration, without requiring complex layer systems while maintaining the desired “globally curved” geometry of the surface of the base material. This is accomplished by applying a self-organized etch process, which may directly act on the surface if substantially comprised of silicon, or the self-organized etch process may be used for producing an appropriate structure in a different base material. In this case, a reactive plasma atmosphere is established so as to include at most two different gas components including oxygen and a reactive gas for etching silicon by adjusting process parameters such that a self-masking effect for generating a nanostructure is obtained. The etch process is performed as a single step process without any further working gases.

After establishing the plasma atmosphere the silicon surface is exposed to the etch plasma without using any further process steps, in particular no further measures are required so as to obtain a dedicated micro masking of the silicon surface. Nevertheless, virtually a “defect-free state” is obtained in the sense that substantially no additional defects, for instance in the form of etch byproducts, are generated in the reactive plasma. Also lattice stacking faults are substantially avoided, thereby preventing a change of semiconductor characteristics by the etch process, if this is important for the further production of the curved surface. These are structural features of the silicon structure obtained, which are advantageous for further steps, in particular when the optical component under consideration is based on silicon. If this structure serves as a basis for the fabrication of the surfaces of other base materials, these advantageous characteristics may also be exploited for the required process steps. For instance, by means of these characteristics the fabrication of a template may be accomplished on the basis of micro structuring processes that are well known for crystalline silicon. An efficient adaptation of the index of refraction in the curved surface is accomplished by adjusting the aspect ratio of the pin-type structure being formed in the reactive plasma atmosphere to a value of 4 or greater by controlling the process time, wherein a masking of the silicon surface, by photoresist or other substances, such as aluminum, gold, titanium, polymers, water or possible surface contaminations and the like, is not required.

The produced pin-type structures have an appropriate shape for applications in curved surfaces in the range of the visible light and also in the infrared range. The shape of the pin-type structures generated by the self-organized masking of the etch process has, in addition to the aspect ratio of >4, also a “pyramid-like” shape wherein a very acutely emanating tip end is produced, while at the bottom of the shape that tapers in a pin-like to manner at the top thereof, a moderately flatly terminating area is generated, which bottoms out in a shallow manner. The lateral dimensions increase towards the bottom. The pyramid-like structures having a pin-like tip and being specified in this manner have a pronounced spacing of at least 50 nm so that too closely spaced adjacent pins are avoided despite the high density of pins. Such too densely packed pins would merge into a greater structure and here would stop the etch process.

The shapes specified by the given circumscription are not all identical, however on average and according to the statistical distribution, they appear regular and are individually sharply delineated. Their density distribution nevertheless is approximately 50 “pyramid-like pins” per μm², at any rate significantly below 100 pins per μm², with a height of the pyramid-like pins being above 400 nm, in particular in the range of approximately 500 nm, while a spacing between the pyramid-like pins is of substantially comparable depth. Between such adjacent pins a spacing with a width of at least 50 nm remains, which spacing merges at the lower foot of the pyramid-like progression only at a position where the foot area bottoms out in a relatively flatly and virtually shallow manner. The pyramid is not to be understood as to require four sides; even more sides are possible, up to a polyside pyramid shape and up to a substantially round shape in cross-section.

In other words, most of the regularly distributed pyramid-like pins at the top thereof represent a pyramid-like shape in the subsequent height section and are laterally broader at the foot area with a relatively flatly bottoming out, i.e. different from a pyramid-like shape.

These pyramid-like pins may be exposed to substantial mechanical stresses so that they may act directly as an adaptation layer for the index of refraction or as an antireflective coating when the silicon also acts as base material, or when further steps are required, for instance the application of a passivation material, usage as a nano template for the fabrication of pin-type tips in other materials, oxidation processes and the like. In other cases, the nanostructures may be bent or “blurred” upon a corresponding load but they will not be destroyed. Mechanical stresses of the following type will not result in a destruction of the nano pin structure that would otherwise result in disadvantageous consequences with respect to the reflection of the nanostructure including the pyramid-like pins:
uniform area-like pressure perpendicular to the pins;
AFM in contact mode;
profilometer.

A profilometer stylus of the profilometer exerts a pressure between 0.1 and 10 mg on the sample to be measured (the nano surface including the pyramid-like pins). The profilometer stylus is very acute, however rapidly gains in its diameter so that upon moving across a measurement sample a recess of a depth of 5 μm and with a width of 1 μm may no longer be resolved in a precise manner in the measurement image At a pressure of normally 5 mg and a movement of the profilometer stylus with a speed up to 100 μm per second across the nanostructure there was no disadvantageous impact observed on the reflection characteristics of the nanostructure as might occur upon destroying the pyramid-like pin structure.

It total, a very advantageous antireflective behaviour could be observed for the produced (area-like) nanostructure, even for an average length or height of the structures of approximately 400 nm to 500 nm and below 1000 nm, in the visible range and also up to 3000 nm wavelength or greater with curved surfaces of, for instance, micro lenses and the like.

Also, this feature indirectly specifies the structures of the “pyramid-like pins”. The “total” reflection is below 0.7% for a wavelength range between 400 nm and approximately 800 nm (scattered and direct reflection). In an extended range between 180 nm and 3000 nm the (total) reflection is below 2% wherein practically only the scattered reflection provides a contribution. The reflection is a physical characteristic of the nanostructure, which is reproducible, measurable and comparable with other structures.

Without intending to restrict the present invention to the following explanation, investigations indicate that the efficient self-organized masking (as “self-masking”) is achieved by the etch process itself and not by already existing or specifically added substances. Corresponding measurements on the basis of Auger electron spectroscopy (AES) and energy dispersion xray spectroscopy (EDX) show that the masking effect is caused by SiOₓ, so that a strong shielding effect is achieved by the locally formed silicon oxide. In total, this results in a moderately low silicon consumption during the fabrication of the pin-type structures having the “pyramid-like” shape with concurrently a high aspect ratio and an existing spacing so that the inventive method is advantageously and efficiently usable in semiconductor production at a high degree of s process compatibility in many fields.

Any defects are not taken advantage of for a dedicated mask formation. Instead of a dedicated masking prior to the etch process the previously described self-organized masking caused by the specific process conditions is used during the etch process. By combining the self-masking and the etching during the RIE process the plasma allows the generation of self-organized pyramid structures in the nanometer range. In this way it is possible to convert a smooth silicon surface into, seen from a statistical point of view, a regular and virtually ordered pin structure in the nanometer range, that is, with lateral dimensions below the usual light wavelengths, for instance a wavelength range Is of the visible light. In total, in this way even across a globally curved surface, that is, the radius of curvature is much greater than the lateral dimensions of the nanostructures, an excellent homogeneity of the reflection behaviour is achieved.

Furthermore, the number of contamination defects that are typically caused by etch byproducts and crystal faults that are encountered in conventional plasma assisted methods may significantly be reduced or within measurement accuracy may substantially be avoided on the basis of a single etch step. In this sense, such defects could not be observed by RHEED, CV measurements, TEM or PDS (photo thermal deflection spectroscopy)—due to the inventive etch regime. Also, a simple photo diode, for instance for blue light, the surface of which was processed with this technique, did not exhibit any specifics which indicate an increased defect density. Hence, the nanostructure may be provided in a single plasma etch step with a quality that does not require any further material removal.

The structures produced by the method do not exhibit a shadowing effect at high edges. In this way it is for example possible to pattern areas of a few micrometers, even if the area is laterally enclosed by a structure of a height of 5 micrometers so that a high flexibility is obtained for the fabrication of corresponding curved surfaces of optical components and for the positioning thereon the layer for adapting the index of refraction.

The patterning of the silicon is accomplished by the plasma in the RIE process. These structures are strongly deepened by the etch process, thereby resulting in the structures in the nanometer range having an enormous aspect ratio.

The structure generated in this way has a low-defect nanostructure surface, which may be formed on the base material of the optical device. A height of the isolated pyramid-type pins is at least 400 nm and a spacing is at least 50 nm. The height is between 400 nm and 1000 nm, as may be seen in pictures of electron microscopy images, as will be described later on in more detail The representation by images is to replace a structural circumscription of the pyramid-like pins and of their surroundings, which description is possible in a restricted manner only. For a comparison it may be referred to the John Hancock Centre in Chicago, which is approximately 350 m high, has a slightly pyramid-like shape and has a lateral dimension at the bottom (without a shallow moderately flat bottom out) of approximately 85 m. This structure is formed for instance in silicon with a scale factor of 10⁹ however many times positioned side by side and only hardly to be made visible and clearly describable in this scale on the basis of currently available image processing methods. This task is, on the one hand, not easy and is, on the other hand, solved by measuring and representing the effects of these structures.

According to the subject matter claimed herein (claim 1 and claims 6, 19 and 27) a layer for adapting the index of refraction of the base material having a curved surface to the surrounding medium is formed by using the specified process also explained above so that a desired broadband antireflective behaviour is achieved.

A method for fabricating an optical component is claimed. The fabrication of a globally curved surface is accomplished in the base material.

By means of the (globally) curved shape rays of light incident on the curved surface experience a change in the propagation direction in the sense of a refraction. The light rays also enter the curved surface.

A layer for adapting an index of refraction is produced with a nanometer structure in the base material. The global curvature of the surface is thereby maintained. The adaptation layer is formed by using the described process. It comprises:
Establishing a reactive plasma atmosphere on the basis of at most two different gas components.
   The gas components are oxygen and a reactive gas for etching silicon without an intermediate step. In particular, no further gas components are involved.
   By adjusting process parameters a “self-masking effect” is obtained that results in the generation of a nanometer structure (of such a layer) having pin-like nanostructures.
By controlling the process time for exposure to the plasma atmosphere the aspect ratio of the pin-type structures developing in the plasma atmosphere (self-masking) is adjusted to a value of at least 4.

The base material of the optical component may directly be silicon (claims 19 to 26, claims 10 to 13), which may, if required, be further processed after patterning, for instance it may at least partially be converted into oxide, or layers may be formed from pin-type silicon structures by casting such that these structures then allow a gradual transition in the index of refraction in a plurality of materials. In this case, the base material may also concurrently obtain its global surface curvature by a casting process (claim 5), so that a high flexibility for the material selection and an efficient manufacturing method for providing the antireflective behaviour of the curved surface are provided.

The inventive surface structure for globally curved geometries may thus be used in a plurality of possible devices, for instance opto electronic circuits (claims 15, 22, 31), but also in absorption elements for control and measurement purposes (claims 23, 32), wherein nearly the entire light intensity impinging on the curved surface may be absorbed and thus be detected.

Also a significant increase of the efficiency of devices may be achieved, which are provided for transmission (claim 33), for example a lens, wherein one or both surfaces may efficiently be made antireflective.

As is described in the following the temperature of the silicon wafer and the ratio of the working gases at the point of reaction are appropriately adjusted at the silicon surface.

In one preferred embodiment the temperature of the silicon surface is selected to 27° C., preferably in the range of ±5° C. Hence, an efficient adjustment of the further process parameters, for example the flow rates specified in the claims and the following description, may be achieved since the temperature typically representing a “sensitive” parameter is selected in a very precise manner.

Also the process pressure and the plasma power are appropriately adjusted to each other, as is explained in the following description in order to obtain the desired aspect ratio while at the same time reducing a contamination rate and crystal fault density.

In particular, the ratio of not more than two working gases is adjusted by maintaining an oxygen component in the specified manner such that etch removal and self-masking are balanced. In this way, the structuring and also the required lack of defects is ensured (no additional defects due to the etch regime).

In the present method the absolute parameter values may efficiently be adapted to the fraction of the open (or exposed) silicon surface that acts as a basis for forming the curved surface. When the Si surface is covered by a mask layer, for instance by oxide or silicon nitride, with a high area fraction, since for example only certain areas or of a template are to receive a corresponding pin structure, this may at least be balanced by an increase of the reactive gas fraction, for instance the SF₆ fraction, in particular also for an increase of the SF₆ fraction and a concurrent reduction of the oxygen fraction and a concurrent increase of the process pressure.

By means of the previously described process it is possible to fabricate the desired nanometer structures with a high adjustable aspect ratio within a short time interval by means oft for instance, a simple RIE tool having a parallel plate reactor. This is possible for a large area as well as with a dedicated adaptation of process parameters also in smallest areas so that individual devices, for instance optical active areas of opto electronic devices and the like, may be provided with a corresponding nanostructure even for sophisticated geometries including a desired curvature in a dedicated manner without negatively influencing other device regions. Regions that are not to be patterned may readily be protected, for instance by an oxide mask. Moreover, due to the low contamination rate and the low crystal fault density a direct further processing after fabricating the area-like nanostructure may be accomplished without requiring complex preparation and/or post processing techniques.

A further appropriate method comprises the establishment of a reactive plasma atmosphere including oxygen and a reactive gas that consists of a mixture of HCl and BCl₃ for etching silicon without further process steps by adjusting process parameters that result in a self-masking effect for producing a nanostructure with pin-type structures. Also in this case a self-organizing masking effect may be achieved so that the previously described characteristics (or shapes) of the nanostructures are obtained.

By this method a nanostructure—extending like an area—may be provided that comprises statistically distributed single-crystalline pin-type silicon structures that are formed on a single-crystalline silicon base layer, wherein the aspect ratio of the pin-type silicon structures is 4 or greater, and wherein the crystal fault density in the silicon structures is not greater than in the silicon-based layer. If required, these structures may further be processed, as is described above, in order to form therefrom the antireflective coating for the curved surface.

The nanostructure thus comprising silicon structures having lateral dimensions that are typically below the wavelength of the visible light may thus be used in an efficient manner as a layer in devices in which a gradual change of the index of refraction between silicon or any other base material and the medium surrounding the base material is desired. In this manner an adaptation of the index of refraction between the base material and the medium is achieved. In this way, the reflection behaviour and/or the transmission behaviour of opto electronic devices comprising a curved surface for achieving the desired optical effect is significantly improved.

The inventive subject matter has, among others, the advantages that a broadband antireflective behaviour for curved silicon surfaces or other optically effective surfaces is achieved, wherein, when silicon is the base material, no material has to be applied thereon but only the surface has to be modified. There are no adhesion problems, no layer stresses and no restrictions in the optical wavelength range.

Furthermore, the antireflective structure has the advantage that the direct reflection is significantly less compared to the scattered reflection which thus can be suppressed by appropriate means (apertures, dark frames, etc) in its effect. The excellent homogeneity of the antireflective behaviour across a large area minimizes the control effort for produced devices in an enormous manner. For instance, in micro lens arrays not each individual lens needs to be measured.

For fabricating the nanostructure in the surface the described RIE silicon etch process is applied. The produced structures may be converted into oxide by oxidation of silicon, thereby allowing to apply the antireflective structure also to curved oxide surfaces. Also other surface processes, for instance a nitration or other treatments may readily be performed after the generation of the pin-type structure. In addition, also the reduced silicon or oxide nanostructure in the curved surface may be transferred to other materials by casting, for instance for fabricating an imprint tool for other materials.

Further embodiments are presented in the following description.

### BRIEF DESCRIPTION OF THE DRAWINGS

The invention will now be explained on the basis of embodiments while also referring to the drawings. In the drawings:

FIG. 1 illustrates an electron microscopy image of an RIE etched silicon surface in cross-sectional view at a portion that is partially covered by an oxide layer,

FIG. 2 illustrates an electron microscopy image of an obliquely incident electron beam, wherein the homogeneity of the distribution of silicon pins and the depth of the spacing between the pins is visible,

FIG. 3 illustrates a TEM image of the tip of a silicon pin in transmission mode with high resolution,

FIG. 3a illustrates the image of FIG. 3 rotated such that the [001] direction is vertical,

FIG. 4a illustrates the electron microscopy image of FIG. 2 with an obliquely incident electron beam, wherein the homogeneity of the distribution of silicon pins and the depth of the spacing between the pins is visible, here a left section,

FIG. 4b illustrates the electron microscopy image of FIG. 2 with an obliquely incident electron beam, wherein the homogeneity of the distribution of silicon pins and the depth of the spacing between the pins is visible, here an intermediate section,

FIG. 4c illustrates the electron microscopy image of FIG. 2 with an obliquely incident electron beam, wherein the homogeneity of the distribution of silicon pins and the depth of the spacing between the pins is visible, here a right section,

FIG. 5 illustrates the electron microscopy image of FIG. 2 with a obliquely incident electron beam, wherein the homogeneity of the distribution of silicon pins and the depth of the spacing between the pins is visible, here a front section,

FIG. 6 illustrates the electron microscopy image of FIG. 2 with an obliquely incident electron beam, wherein the homogeneity of the distribution of the silicon pins and the depth of the spacing between the pins is visible, here in full representation,

FIG. 7 illustrates corresponding results of the reflection of light at a curved surface with an antireflective coating that is formed on the basis of a pin-type structure, as is also illustrated in the preceding Figures,

FIG. 8a is an optical device having a curved surface prior to forming a pin-type nanostructure,

FIG. 8b is the optical device having the curved surface after forming the pin-type nanostructure,

FIG. 8c illustrates an optical device having a curved surface during the fabrication of a pin-type nano structure by casting using a nano structure formed from silicon, and

FIG. 9a,

FIG. 9b,

FIG. 9c,

FIG. 9d are examples in which the curved surface (having a pin-type nanostructure) has been changed in material composition by a treatment, for instance by an oxidation. Respective narrow lateral sections are illustrated.

### DETAILED DESCRIPTION

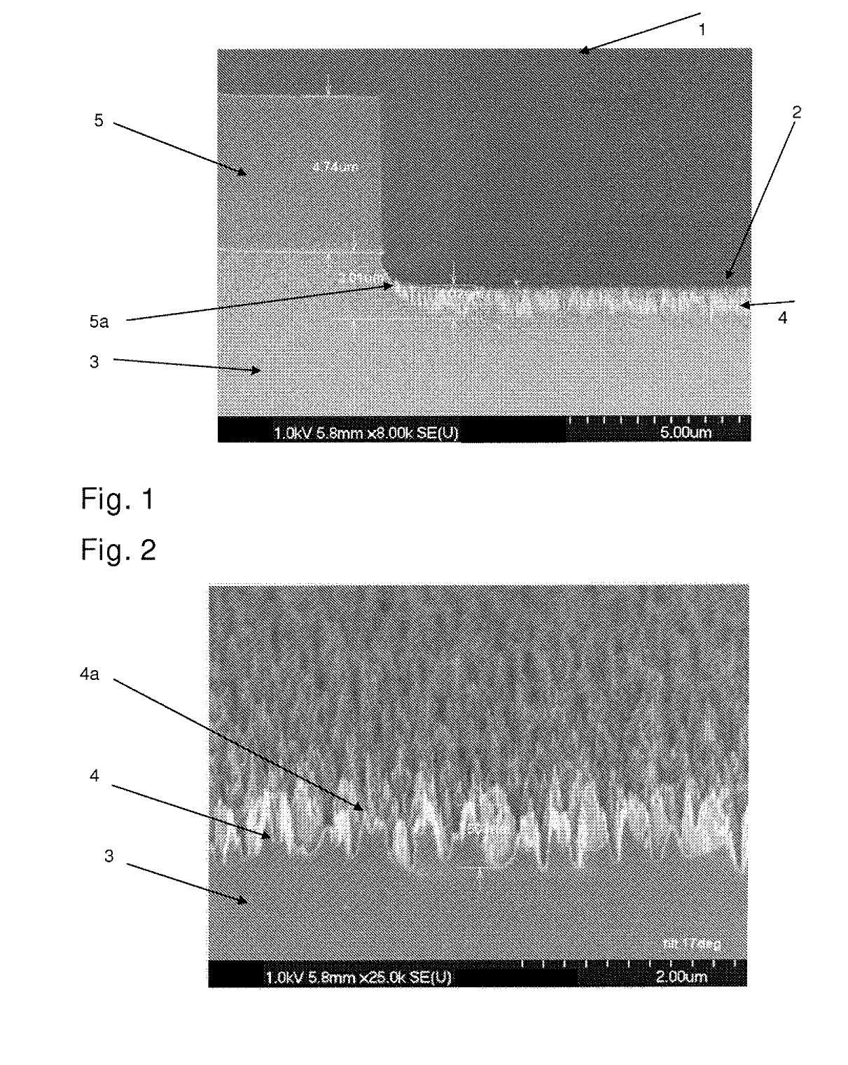

FIG. 1 illustrates a silicon-containing device 1 having a nanostructure 2 that comprises a single-crystalline silicon base layer on which pin-type silicon structures 4 are formed. In this application pin-type silicon structures are to be understood as “pyramid-like” structures having a tip with lateral dimensions of a few nanometers, wherein the tip increases in its lateral dimension significantly towards the bottom so that in the lower portion of the structure a lateral dimension of some 10 nm or up to 100 nm is obtained. The silicon base layer 3 is delineated in this embodiment by a mask layer 5 comprised of silicon dioxide, silicon nitride and the like, wherein the pin-type silicon structures 4 are formed so as to extend to an edge area 5a of the mask layer 5. In the embodiment shown the silicon base layer 3 is part of a silicon wafer with a diameter of 6″ having a (100) surface orientation including a p-type doping that results in a specific resistivity of 10 Ohm*cm.

As already explained above, the base layer 3 may however have any appropriate crystallographic orientation with any type of doping. In alternative examples the base layer 3 is substantially formed of amorphous or polycrystalline silicon.

FIG. 2 illustrates an enlarged section of the nanostructure 2 wherein the angle of incidence of the probing electron beam has a tilt angle of approximately 17° in order to more clearly demonstrate the relations between magnitudes in the lateral direction and in the height or thickness direction of the pyramid-like structures 4. As is evident from FIGS. 1 and 2 the silicon structures 4 have a height that is on average approximately 1000 nm so that in some embodiments a height is obtained that is greater than the wavelength of the visible light. In the scale corresponding to 2 μm 10 scale division are plotted in FIG. 2. In FIG. 1 there are 500 nm per scale division.

Due to the tilted electron beam of 17° the measure indicated as height in FIG. 2 of 603 nm is to be recalculated into the real height. Also the height extension for lower pyramid-like pins, which area effective from approximately 400 nm, may be recalculated up to 60%. This may be accomplished by contraction of FIG. 2 in the height direction by 40% of the illustrated height.

Even pyramid-like structures 4 having an average height around 400 nm exhibit excellent characteristics in many applications. For example, for an average height of 400 nm an excellent antireflective behaviour could be observed in the visible wavelength range and up to 3000 nm.

As is evident from FIG. 1 an average maximum height of the silicon structure 4 may also be substantially at 1000 nm.

On the other hand, FIGS. 1 and 2 illustrate that the lateral dimension of the silicon structures (at the bottom) is less than 100 nm or less than several tenths of nanometers (significantly less) so that on average an aspect ratio of the height to the lateral dimension of 4 or greater is obtained.

The results illustrated in FIGS. 1 and 2 that relate to a 6″ (100) silicon wafer having a p-type doping, a resistivity of 10 Ohms*cm and an area fraction of the oxide mask of greater than 90% (up to substantially 93%), were fabricated in a single step plasma etch process in a process tool having a parallel plate reactor of the type STS 320 with the following parameters:

| | | |
|---|---|---|
| SF₆-Gas flow rate: | 100 | sccm |
| O₂-Gas flow rate: | 20 | sccm |
| Gas pressure: | 70 | mTorr |
| Temperature of silicon wafer: | 27 | degree Celsius |
| Plasma power: | 100 | W |
| Etch time: | 2 | min |

A self-adjusting bias (voltage potential between the plasma atmosphere and the surface to be etched):

Variable around 350 V

In alternative examples comparable results for the nanostructured surface were obtained. Initial parameters and process parameters will be provided below.

For an area fraction of 0.1% silicon and 99.9% oxide mask, with the following parameters.

150 sccm SF₆

20 sccm O₂

91 mTorr

27° C.

100 Watt

4 minutes etch time (process time)

For 100 % silicon surface, that is, a bare silicon wafer.

65 sccm SF₆

23 sccm O₂

50 mTorr

27° C.

100 Watt

10 min to 20 min etch time (process time).

For bare silicon wafers also a process time up to 20 min is useful. With the process an extremely sophisticated antireflective behaviour is then obtained for the surface that is nanostructured by the pins.

In other embodiments gas flow rates up to 50-150 sccm are used for the reactive gas, that is, for SF₆, CₙFₘ or HCl/BCl₃. Gas flow rates of 20 to 200 sccm are used for oxygen. Moreover, in some embodiments the temperature of the substrate and thus of the base layer 3 is adjusted to a range of 27° C.±5° C.

The 6″ wafer rested on an 8″ wafer in the process tool RIE STS 320 and also adjacent to the 8″ wafer the plasma is effective. In first order a power density may be estimated. The plasma power may be adjusted to a range of 100 W, which corresponds to a power density of approximately 4 W/cm² to 12 W/cm² for a 6″ wafer.

From the above statements corresponding parameter values may be determined for other etch tools and other degrees of coverage of the silicon base layer 3 that is to be patterned with the pyramid-like structures. For example, a reduced degree of coverage of the silicon base layer may be taken into consideration by a lower gas flow rate of the reactive gas.

If there is no mask provided, the reactive gas fraction is lower, and vice versa.

Based on the above adjustments the Si-pins 4 having a height of approximately 1000 nm are generally obtained with a statistical distribution in regions not covered by the mask layer 5.

For example, silicon oxide or silicon nitride may be used as the mask layer 5.

Processed wafers having uniform structures (without oxide mask) become completely dark and exhibit a reflection of less that 0.4% for the wavelengths range from 400 nm to 1000 nm while concurrently exhibiting excellent homogeneity of this characteristic across the entire wafer. In particular, in a wavelength range that is extended in both directions and corresponds to 180 nm to 3000 nm wavelength the measurement results still provided an excellent antireflective behaviour with reflections under 2%. The reflections included here (practically exclusively) the reflections into the total solid angle.

Moreover, the crystal damage caused by the plasma assisted single step patterning to process and also the contamination are very low and are below the detection limits of the illustrated embodiments. No residual substances could be detected after the plasma patterning process and the crystal quality of the silicon structures is approximately identical to the crystal quality of the silicon base layer prior to the etch process.

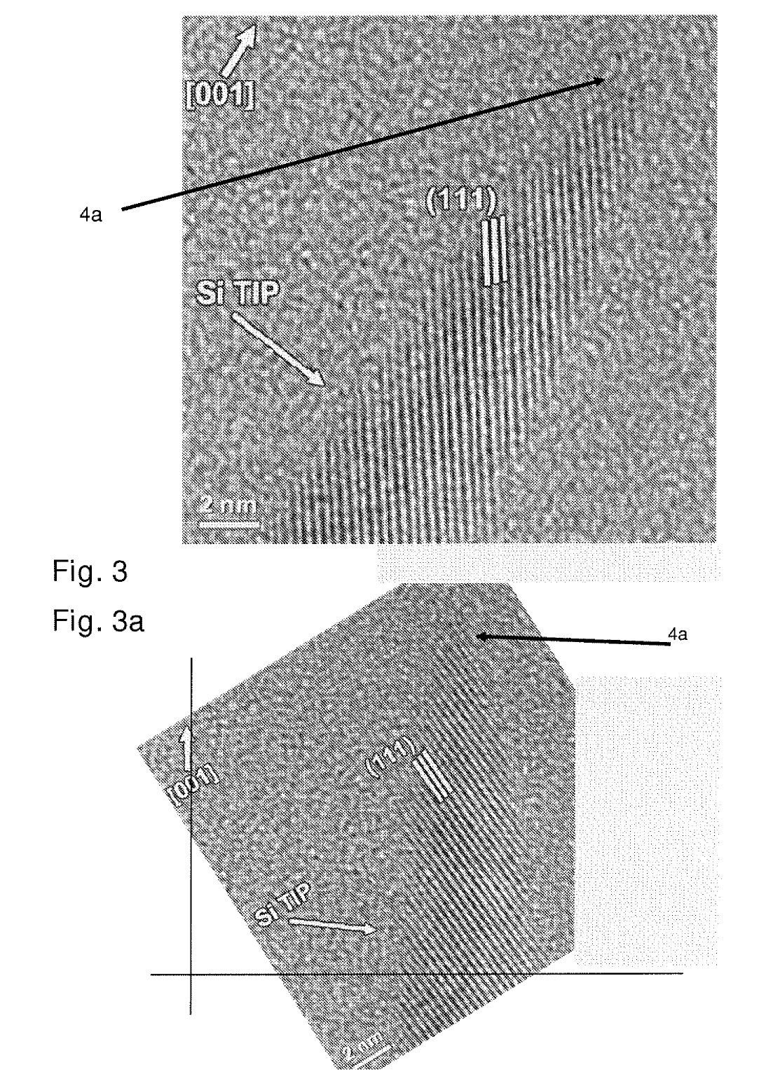

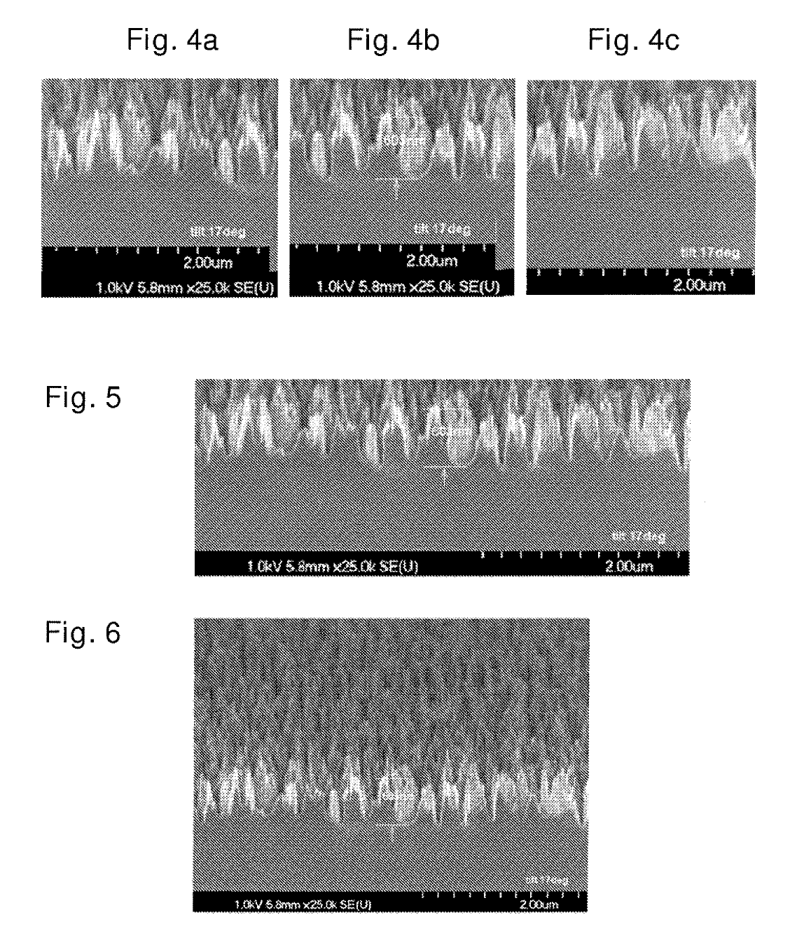

As is evident from FIG. 3 the pin sections of the pyramid-like pins are nearly atomically acute at their tip portions 4a. The lateral dimensions of the tips 4a are a few nanometers. Moreover, individual crystal planes (111) of the single-crystalline pin sections are clearly visible, wherein crystal faults caused by the etch process are not observable.

FIG. 3 illustrates a single tip 4a or an end portion having this tip 4a of a pyramid-like pin 4. As is clearly to be seen the pins are nearly atomically acute, that is, the lateral dimensions of the end portions 4a are a few nanometers and are thus less than 10 nm. In the illustration of FIG. 3 moreover the crystallographic direction perpendicular to the surface of the silicon base layer 3 is illustrated. This direction corresponds to a [001] direction, since for the embodiment shown the surface orientation is a (100) orientation. As is evident, the end portion comprising the acute tip 4a substantially extends along the square bracket [001] direction with a slight deviation of less than 10° so that the structure elements are substantially perpendicularly aligned to the normal of the surface of the base layer 3 with a deviation of several degrees.

In FIG. 3a the [001] direction is perpendicularly oriented. Based on FIGS. 3, 3a also the inclination of the sidewalls of a pyramid-like pin may coarsely be determined. The inclination is approximately 4° with respect to the normal [001].

There are no crystal faults caused by the etch process in the individual crystal planes of the single-crystalline pin. In the configuration of the base layer shown the crystal planes that are visible correspond to the (111) planes.

Due to a strongly cleft surface after the process the area is significantly increased, thereby also significantly changing the characteristics. The enlarged surface area exhibits a much greater area of attack for adhering molecules and may thus significantly increase the sensitivity of sensors.

For example, it has been determined that gases may remain localized in the structure for a long time. In the optical field the pyramid-like structures 4 are interesting insofar as a lateral size is less than the light wavelength (VIS/NIR) and due to the pin-type shape, ie. the reduced lateral dimension of the tip portions 4a and the moderately large dimension at the bottom of the pyramid-like structure, and due to the high aspect ratios a nearly perfect gradient layer is provided. The index of refraction changes gradually from the index of refraction of the silicon to the index of refraction of the medium surrounding the nanostructure 2, for instance air, so that a corresponding layer comprising the structures 4 may be referred to as an adaptation layer for the index of refraction between two media.

Hence, the nanostructure 2 allows an adaptation of impedance or an adaptation of the index of refraction, thereby resulting in an excellent broadband suppression of reflection.

Thus, a wide field of applications for the nanostructure 4 is obtained in many micro devices and also in fields, such as solar cells, sensors and the like, in which in particular curved surfaces having an improved optical behaviour are required, such as micro lenses, arrays of micro lenses and the like.

The embodiments thus provide methods and structures in which silicon structures having a large and adjustable aspect ratio are provided, wherein due to the (specific) parameter adjustment in the self-masking plasma etch process based on a single etch step a contamination and generation of plasma caused crystal faults is kept low so that the resulting structure may directly be used at low effort for the single step patterning process without requiring additional post process steps, if pin-type silicon structures with high single crystalline quality are required.

Moreover, additional complex surface preparations or additional measures for producing a micro masking are not required. A preceding conditioning or preparation may be omitted.

By means of an RIE standard etch process for silicon a plurality of nearly crystal defect-free pin-like structures is obtained, among others, with a high aspect ratio and with nano dimensions, on the surface of a silicon wafer without any additional patterning measures (e-beam, interference lithography or the like) by self-organization, thereby, among others, achieving a broadband antireflective behaviour and hence allowing an application to curved surfaces.

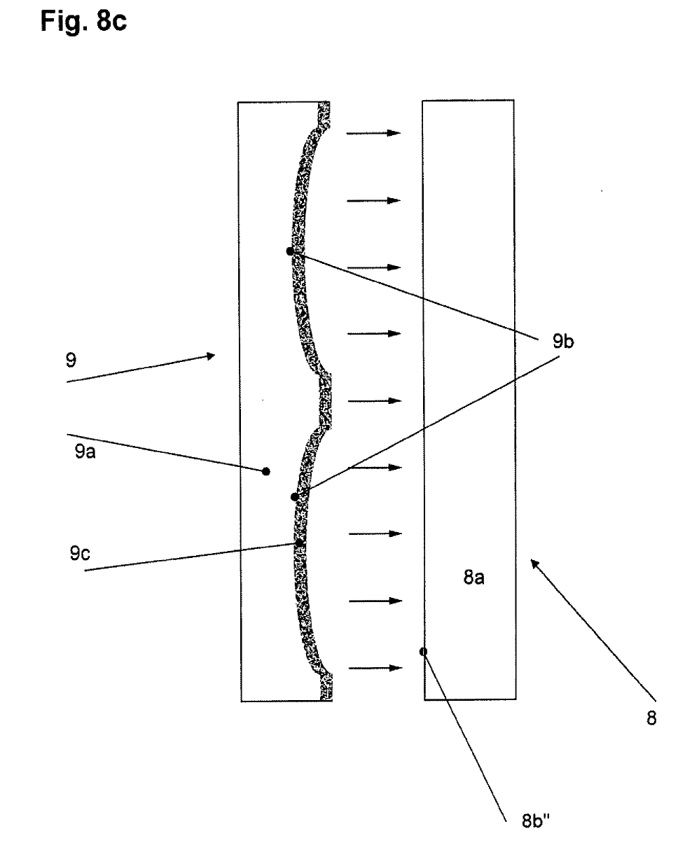

FIG. 8a schematically illustrates a cross-sectional view of an optical device 8, which in the present case represents a micro lens system (micro lens array). The device 8 may be an integral part of a complex microstructure device, for instance of an opto electronic circuit, in which optical and electrical signals are processed. Also, mechanical components may be provided in order to obtain the desired function. For convenience, corresponding additional components are not illustrated.

The device 8 comprises a base material 8a that is appropriate for the fabrication and the function of the device, or that may be converted into an appropriate material in a later stage. For instance, the base material is silicon, if it may also act as a surface material, or it may at least be converted into an appropriate material, for instance into an oxide, as is described later on in more detail. The base material 8a comprises at least one, preferably several, curved surfaces 8b, 8b′, wherein the curvature is to be understood as a global curvature in the sense that the radius of curvature is significantly greater than any dimension of nanostructures, for instance the nanostructures 4, that are to be formed in the surface 8b. The “global” curvature of the surface 8b is defined by a dimension that is greater than at least a micrometer, wherein a structuring by using the nanostructures 4 does not result in a significant change of the global curvature.

As is illustrated in FIG. 8a a maximum thickness of the base material 8a is given by the value x.

FIG. 8b illustrates the device 8 (the micro lens array) after an etch process as is described above in detail so that a layer 8c is obtained that comprises corresponding pin-type nanostructures, for instance in the form of the structures 4, and which thus results in an adaptation of the index of refraction of the base material 8a with respect to the surrounding medium, for instance air or any other material, as is explained above. Due to the single step etch process having the above-described characteristics, the layer 8c is obtained with a pronounced homogeneity with respect to the characteristics of the nanostructures formed therein as well as in view of layer thickness, without resulting in a significant geometry dependent influence caused by the global curvature. Also the overall dimensions x of the device 8 substantially remain unchanged, since the s etch process may be adjusted such that an undesired silicon consumption is small, since a corresponding self-masking effect starts immediately at the beginning of the etch process, as is explained above.

The layer 8c may thus be fabricated while avoiding the application of additional material layers, wherein also further post processing steps may be omitted, when the base material 8a in the form of silicon is appropriate for the application of the optical device 8. In this manner, stress in the device is avoided, which may conventionally occur when several layers are to be applied for obtaining the antireflective behaviour.

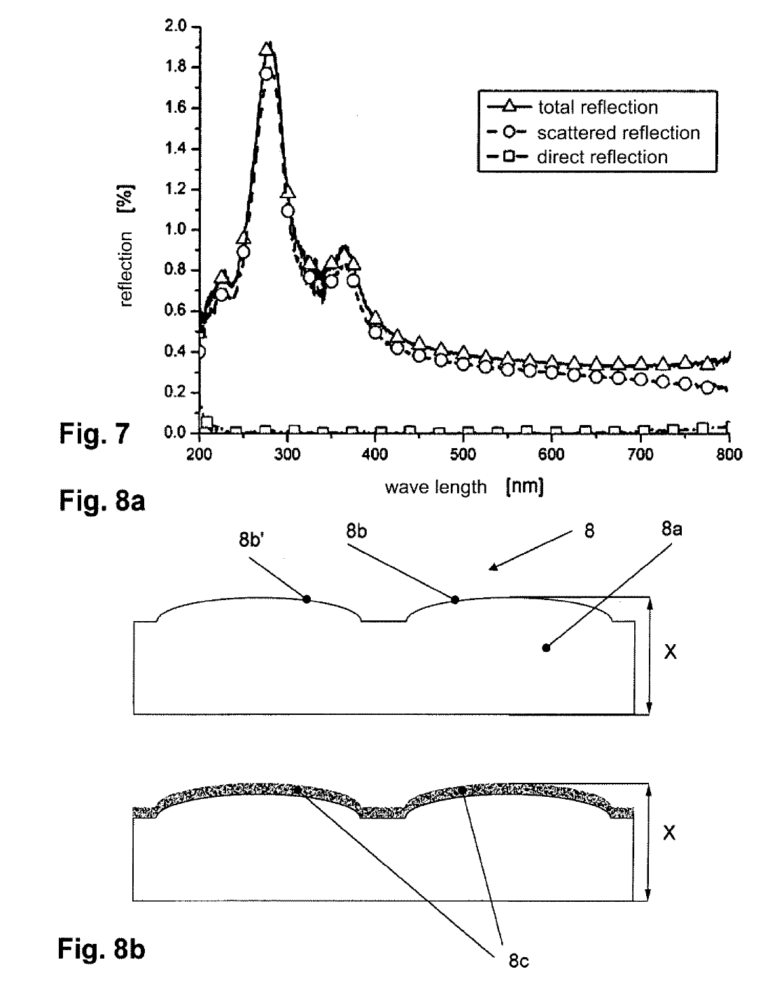

FIG. 7 illustrates corresponding measurement results of the direct and scattered reflection, as are typically achieved. As is evident in a range of approximately 400 nm-800 nm the total reflection of the scattered reflection is dominant and is very low. For this wavelength range the total reflection is 0.7% or even less.

FIG. 8c illustrates the device 8 in a further embodiment, wherein the base material 8a is comprised of a different material which, in the embodiment shown, is provided in a deformable state. For example, a plurality of polymer materials may be applied in a deformable state at a corresponding treatment or may be converted into such a state in order to allow a subsequent patterning of the surface. For this purpose, a template 9 comprises a single curved or multiple curved surface 9b that is formed of a template material 9a. The surface 9b comprises a layer 9c including a nanostructure that has geometrical characteristics, as are previously described in the context of the nanostructure 4. For example, the template 9 may be a silicon carrier, in which in addition to the surface 9b also the layer 9c is formed.

It goes without saying that the template 9 may also be formed from a different material, which in turn may be patterned on the basis of a silicon-based carrier material in a similar manner as is described above. For convenience, in the following it may be assumed that the template 9 or at least the layer 9c is comprised of a silicon-containing material.

The template 9 may then be brought into contact with the deformable base material 8a so that the structure of the layer 9c is first transferred into the surface 8b″ and then into the base material 8a, thereby also forming the nanostructures therein. In this embodiment concurrently the global curvature is also produced by the corresponding casting process in the surface 8b (and the base material 8a) provided as a negative form in the template 9.

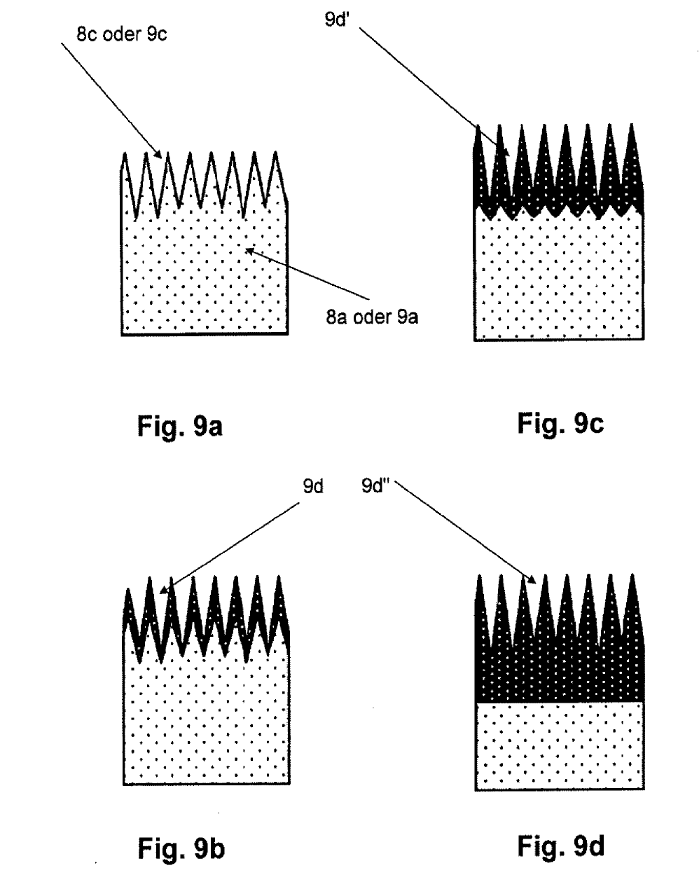

FIGS. 9a to 9d illustrate narrow lateral sections or portions of the curved surfaces 8b, 8b′ or 9b of an optical device 8 or of a template 9, wherein, starting from the silicon nanostructure, a different material composition for the layer 8c, 9c is provided.

FIG. 9a illustrates the layer 8c, 9c, as is obtained from the previously described etch process, according to a lateral section.

FIG. 9b illustrates the layer 8c, 9c after a certain duration of the surface modification, which in a second embodiment comprises an oxidation process such that an oxidized section 9d is formed and extends into the depth. Also in this case, only a portion of the total curved surface is illustrated.

FIG. 9c illustrates the layer 8c, 9c as a further example when the individual pin-type structures, indicated as 9d′, are completely oxidized.

FIG. 9d illustrates the layer 8c, 9c as still a further example when the oxidized portion 9d″ extends still further into the base material 8a, 9a.

In this manner, materials other than silicon may directly be formed in curved surfaces of optical devices, for instance when the optical or electrical characteristics of silicon are not appropriate for the application. Also corresponding templates may be formed on the basis of other materials, for instance silicon dioxide, thereby providing a high flexibility for the fabrication of templates for the antireflective coatings, since established fabrication processes from the field of microelectronics, for instance selective etch processes and the like, may be applied in combination with silicon dioxide, nitrided silicon and the like.

In the embodiments shown devices having a curved optically effective surface are illustrated. It goes without saying that also one or more additional surfaces, plane or curved, may be provided and may receive the layer 8c, 9c in order to obtain improved optical characteristics.

1. A method for fabricating an optical device comprising:
forming a globally curved surface in a base material, in order to change direction of rays of light incident on (and penetrating) the curved surface;
forming a layer for adapting an index of refraction by generating a nanometer structure in the base material while maintaining the global curvature of the surface, wherein the adaptation layer is formed by using a process that comprises:
establishing a reactive plasma atmosphere on the basis of at most two different gas components that are or include oxygen and a reactive gas to etching silicon without an intermediate step by adjusting process parameters, which result in a self-masking effect for generating the nanometer structure having pin-type structures;
adjusting an aspect ratio of the pin-type structures being formed in the plasma ambient to a value of 4 or greater by controlling a process time for the exposure to the plasma atmosphere.

2. The method of claim 1, wherein the base material comprises silicon and the process is directly applied to the base material for structuring the curved surface.

3. The method of claim 2, wherein the process further comprises an oxidation process after the fabrication of the nanostructures so as to at least partially oxidize the same.

4. The method of claim 1, wherein forming the layer for adapting the index of refraction comprises: forming a template by means of the process and using the template for casting the nanostructure contained therein into the base material.

5. The method of claim 4, wherein the template generates the curved surface in the base material in addition to the nanostructure.

6. An optical device comprising an optically effective curved surface for light in the range of substantially 400 nm to 800 nm, wherein
an adaptation layer for an index of refraction (8c) is provided for broadband anti-reflecting in the range of 400 nm to 800 nm,
the adaptation layer is made of pin-type nanostructures and has the characteristic to cause a total reflection of 0.7% or less.

7. The optical device of claim 6, wherein the nanostructures in the adaptation layer for the index of refraction are statistically distributed and have an aspect ratio of 4 or greater.

8. The optical device of claims 7, wherein a layer thickness of the adaptation layer for the index of refraction is approximately 500 bis 1000 nanometer.

9. The optical device of claim 8, wherein an average density of the nanometer structures in the adaptation layer for the index of refraction is 100 per nm² or less.

10. The optical device of claim 9, wherein the nanostructures comprise silicon.

11. The optical device of claim 10, wherein the nanostructures are made of silicon.

12. The optical device of claim 10, wherein the nanostructures are comprised of silicon dioxide.

13. The optical device of claim 10, wherein the pin-type structures consist of silicon coated by silicon dioxide.

14. The optical device of claim 9, wherein the nanostructures are formed of a material that is deformable by imprint techniques.

15. The optical device of claim 6, wherein the device represents a part or several parts of an opto electronic circuit.

16. The optical deice of claim 6, wherein the device is appropriate for transmissive light.

17. The optical device of claim 16, wherein a second surface is provided that is provided with a second layer for adapting an index of refraction and includes nanostructures.

18. The optical device of claim 6, which represents an absorbing device for control or measurement tasks.

19. An optical device having a curved surface that includes—for a broadband antireflective behaviour—pin-type structures with nanometer dimensions made of a silicon-containing material and having an aspect ratio of greater than 4:1.

20. The optical device of claim 19, wherein the pin-type structures are formed or may be formed by a single step self-masking etch process.

21. The optical device of claim 19, wherein an average density of the pin-type structures of the curved surface is between 50 and 100 pins per nm².

22. The optical device of claim 19, wherein the device represents a part or several parts of an opto electronic circuit.

23. The optical device of claim 19, which represents an absorbing device for control or measurement tasks.

24. The optical device of claim 20, wherein the pin-type structures consists of silicon.

25. The optical device of claim 20, wherein the pin-type structures consist of silicon dioxide.

26. The optical device of claim 20, wherein the pin-type structures consist of silicon coated with silicon dioxide.

27. An optical device having a curved surface comprising pin-type structures having nanometer dimensions with an aspect ratio of greater than 4:1 for broadband antireflective characteristics, wherein the material of the pin-type structures is substantially free of silicon.

28. The optical device of claim 27, wherein a configuration of the pin-type structure is equivalent of a silicon structure that can be formed in silicon by a self-masking single step plasma etch process.

29. The optical device of claim 28, wherein the pin-type structures are contained in a material layer that is structured by casting a corresponding silicon or silicon dioxide layer having a pin-type structure.

30. The optical device of claim 29, wherein an average density of the pin-type structures of the curved surface is between 50 and 100 pins per nm².

31. The optical device of claim 27, wherein the device represents a part or several parts of an opto electronic circuit.

32. The optical device of claim 27, wherein the device represents an absorbing device for control or measurements tasks.

33. The optical device of claim 27, wherein the device represents a part appropriate for transmitting light, wherein the surface of one side or the surfaces of both sides are antireflective.
